(19) United States
(12) Patent Application Publication
(10) Pub. No.: US 2006/0220878 A1
(43) Pub. Date: Oct. 5, 2006

(54) Wireless tag package

(75) Inventor: Yoshinori Asai, Izunokuni-shi (JP)

Correspondence Address: PEARNE & GORDON LLP, 1801 EAST 9TH STREET, SUITE 1200, CLEVELAND, OH, 44114-3108, US

(73) Assignee: TOSHIBA TEC KABUSHIKI KAISHA, Tokyo (JP)

(21) Appl. No.: 11/375,971

(22) Filed: Mar. 15, 2006

(30) Foreign Application Priority Data
Mar. 25, 2005 (JP) JP2005-088894

(51) Int. Cl. G08B 13/14

(52) U.S. Cl. 340/572.8; 340/572.1

(57) ABSTRACT

An adhesive to attach a package to an article is applied on a back face of a base sheet. An adhesive to fix a wireless tag and adhere the cover sheet to the base sheet is applied on a surface of the cover sheet oppositely facing the base sheet. The adhesive to be applied to the cover sheet is not applied on a slightly narrower zone than the size of the tag on the wireless tag adhering zone.

### CROSS-REFERENCE TO RELATED APPLICATIONS

This application is based upon and claims the benefit of priority from the prior Japanese Patent Application No. 2005-88894, filed on 25th Mar., 2005; the entire contents of which are incorporated herein by reference.

### BACKGROUND OF THE INVENTION

1. Field of the Invention

The present invention relates to a wireless tag package in which a wireless tag is easily reusable.

2. Description of the Related Art

In recent years, there has been used a wireless data carrier to which an unique wireless ID is set, which has an information rewritable memory area and which is capable of reading a wireless ID or writing and reading arbitrary information with no-contact using wireless.

For example, wireless data carriers respectively having a unique wireless ID are attached to or incorporated in postal articles, delivered goods or the like, and moving objects are identified.

It is not appropriate that a once-used wireless tag is discarded as it is, therefore, it has been proposed that a wireless tag enclosure pinched with a base material is prepared, and a wireless tag of the content is taken out from the wireless tag enclosure, collected and reused (For example, JP-A-2002-157569).

In the above-mentioned proposal, the wireless tag in the enclosure is not fixed, and the wireless tag which moved in the enclosure is damaged, thereby resulting in that stable communication may not be performed.

Further, the enclosure is broken to collect the wireless tag, therefore, the postal articles, delivered goods and the like which the enclosure is attached may be damaged.

Additionally, there is a problem that the wireless tag is easily damaged in the enclosure from which a part of the wireless tag is exposed.

### BRIEF SUMMARY OF THE INVENTION

According to embodiments of the present invention, it is an object of the present invention to provide a wireless tag package in which a wireless tag is easily collected and easily reusable without damaging the wireless tags and articles or the like to which the wireless tags are attached.

The present invention may provide a wireless package, comprising: a wireless tag, a base sheet on which the wireless tag is placed on a predetermined zone along one side of the front surface and an adhesive is applied on the back surface, and a cover sheet adhered along the one side of the front surface of the base sheet on which the wireless tag is placed, wherein an adhesive is applied on a substantially entire surface other than an area excluding the both ends of the wireless tag from the predetermined zone on a surface of the cover sheet oppositely facing the base sheet.

### BRIEF DESCRIPTION OF THE DRAWINGS

FIG. 1 is a schematic diagram showing a structure of a wireless tag package according to an embodiment of the present invention;

FIG. 2 is a pattern cross section of the wireless tag package according to the embodiment of the present invention; and

FIGS. 3A and 3B are drawings explaining an adhesion of the wireless tag package.

### DETAILED DESCRIPTION OF THE INVENTION

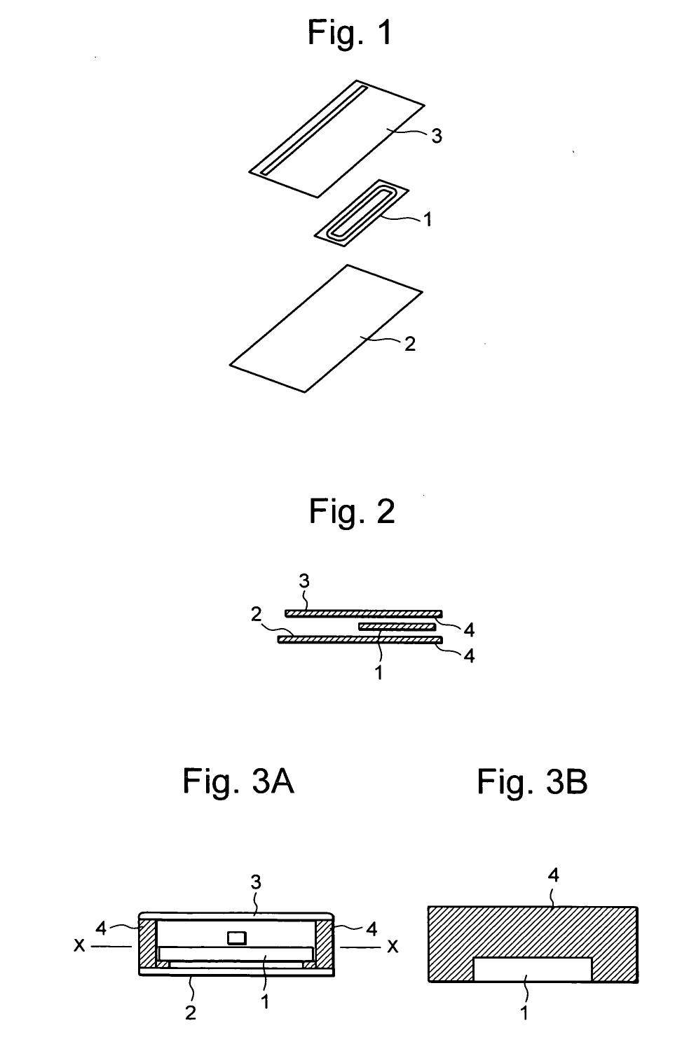

A wireless tag package according to an embodiment of the present invention will be described with reference to the drawings. The same parts are denoted with the same reference numerals. FIG. 1 is a schematic diagram showing a structure of a wireless tag package. FIG. 2 is a pattern cross section of the wireless tag package.

As shown in FIG. 1, a wireless tag package is constituted by a wireless tag 1, a base sheet 2 and a cover sheet 3.

The wireless tag 1 is a type of wireless data carrier, and an independent component for which a tag antenna capable of transmitting and receiving and IC chips are integrally molded on a base plate. The IC chip is provided with a power source generating section for supplying power source to each section of the IC chip by rectifying and stabilizing modulated radio waves received by the tag antenna, a demodulating section for demodulating the modulated radio waves and sending them to a control section, a modulating section for modulating the data sent from the control section and sending them to the tag antenna, a control section for writing the data demodulated in the demodulating section into a memory and reading the transmission data from the memory to send the transmission data to the modulating section, and a memory.

The memory consists of a wireless ID area for storing a unique wireless ID assigned and set by a manufacturer at the manufacturing stage of the wireless tag, and user area in which user can write any data. The user area records a code for tracking and managing unique to the article, delivered goods or the like to which the wireless tag is attached.

A wireless tag reading device has a transmission and reception antenna, and reads memory data of the wireless tag in the communication area of the transmission and reception antenna with no-contact. A wireless tag reading device comprises an interface section connected, for example, to a higher level device such as personal computer and for transmitting and receiving data, a CPU for controlling communication with the wireless tag and its hardware, a ROM for storing an operation program, a control section constituted by a RAM or the like for temporarily storing data, a modulating section for modulating the data given from the control section to a modulating signal suitable for wireless communication, a transmission amplifier for amplifying the modulated signal and emitting the signal as radio wave, a receiving amplifier for amplifying the radio wave signal received at the antenna unit, and a demodulating section for demodulating the data from the amplified radio wave signal and providing the data to the control section.

When communicating with the wireless tag, a carrier signal is first modulated at the transmission section, and transmitted from the transmission antenna as a radio wave signal for power, then data to be transmitted is modulated in the transmission section so as to be superimposed on the radio wave signal for power, and transmitted from the transmission antenna.

As shown in FIG. 2, an adhesive 4 to attach a wireless tag package 10 to postal articles, delivered goods or the like is applied on a back face of a base sheet 2. A wireless tag 1 is placed on a predetermined zone along one side of the front face of the base sheet 2. A cover sheet is adhered along the one side on the surface of the base sheet on which the wireless tag is placed.

FIG. 3 is a drawing showing an adhesion of the wireless tag package 10, FIG. 3A is a view seen from the side of the wireless tag, and FIG. 3B show a cross-section along X-X. As shown in FIG. 3, the adhesive 4 is applied on a substantially entire surface other than an area excluding the both ends of the wireless tag 1 from the predetermined area on a surface of the cover sheet 3 oppositely facing the base sheet 2.

In other words, the adhesive 4 applied to the cover sheet 3 is not applied on an area slightly narrower than the size of the tag of the adhering area of the wireless tag 1. The wireless tag 1 and the cover sheet 3 are adhered only at both ends of the wireless tag 1. The adhesive 4 is not applied on the wireless tag 1 itself. This is because reuse is difficult. As the wireless tag 1 is not freed between the cover sheet 3 and the base sheet 2, there is no disadvantage that the moved wireless tag 1 is damaged and stable communication cannot be performed.

This can prevent the wireless tag 1 from deviating even when the package 10 to which the wireless tag 1 is fixed is adhered to postal articles, delivered goods or the like, or when those articles are handled. Furthermore, as the wireless tag 1 is not adhered on the entire surface between the cover sheet 3 and the base sheet 2, it is easily removed from the package 10 and there is no risk to damage the wireless tag 1, thereby the wireless tag 1 becomes reusable.

As materials of the base sheet 2 and the cover sheet 3, an electrically insulating paper sheet, a synthetic resin film, a synthetic resin sheet or a composite sheet material thereof, and so forth are preferable.

For the adhesive, attachable and removable adhesive has less risk to damage the wireless tag when collected, therefore, for example, urethane based adhesive is preferable.

The present invention is not limited to the above embodiment, and can be embodied on an implementation stage by modifying the structural elements in a range without departing its gist. Furthermore, various inventions can be formed by appropriately combining a plurality of the structural elements disclosed in the above embodiment. For example, some structural elements may be deleted from the whole of the structural elements described in the embodiment. Furthermore, some structural elements in different embodiment may be appropriately combined.

1. A wireless tag package, comprising:
a wireless tag;
a base sheet on which the wireless tag is placed on a predetermined area along one side of the front surface and an adhesive is applied on the back surface; and
a cover sheet adhered along the one side of the front surface of the base sheet on which the wireless tag is placed,
wherein an adhesive is applied on a substantially entire surface other than an area excluding the both ends of the wireless tag from the predetermined zone on a surface of the cover sheet oppositely facing the base sheet.

2. A wireless tag package, comprising:
a wireless tag is enclosed in an overlapping internal faces of a base sheet and a cover sheet whose back faces are applied with an adhesive with only its both ends adhered along one side of the base sheet or the cover sheet, and the overlapping internal faces of the base sheet and the cover sheet except for the enclosing zone of the wireless tag are joined through the adhesive layer.

3. The wireless tag package as set forth in claim 1 or 2, wherein:
the base sheet and/or the cover sheet are any of a paper sheet, a synthetic resin film, a synthetic resin sheet or composite sheet material thereof.

4. A wireless tag package as set forth in claim 1 or 2 wherein:
the adhesive is a urethane-based adhesive.

5. A wireless tag package, comprising:
a wireless tag;
a base sheet on which the wireless tag is placed on a predetermined area along one side of the front surface and an adhesive is applied on the back surface; and
a cover sheet adhered along the one side of the front surface of the base sheet on which the wireless tag is placed,
wherein an adhesive is a urethane-based adhesive and applied on a substantially entire surface other than an area excluding the both ends of the wireless tag from the predetermined zone on a surface of the cover sheet oppositely facing the base sheet.

6. A wireless tag package, comprising:
a wireless tag is enclosed in an overlapping internal faces of a base sheet and a cover sheet whose back faces are applied with an adhesive with only its both ends adhered along one side of the base sheet or the cover sheet, and the overlapping internal faces of the base sheet and the cover sheet except for the enclosing zone of the wireless tag are joined through the adhesive layer, wherein an adhesive is a urethane-based adhesive.
